(19) United States
(12) Patent Application Publication
(10) Pub. No.: US 2002/0085738 A1
(43) Pub. Date: Jul. 4, 2002

(54) Controlling a processor-based system by detecting flesh colors

(76) Inventor: Geoffrey W. Peters, Hillsboro, OR (US)

Correspondence Address: Timothy N. Trop, TROP, PRUNER & HU, P.C., STE 100, 8554 KATY FWY, HOUSTON, TX, 77024-1805, US

(21) Appl. No.: 09/750,524

(22) Filed: Dec. 28, 2000

(51) Int. Cl. G06K 9/00

(52) U.S. Cl. 382/103; 382/107; 382/162

(57) ABSTRACT

A processor-based video capture system may detect the presence of image elements having a human flesh color. In response to the detection of that particular color, a processor-based video capture system may be controlled.

### BACKGROUND

This invention relates generally to processor-based systems and particularly to processor-based systems with video processing capabilities.

Many processor-based systems, such as desktop computers and even laptop computers may include video processing capabilities. For example, many processor-based systems are sold with a video camera. In many cases, central processing units can perform complex pixel-by-pixel analysis of live video. Thus, it is possible not only to record video using a processor-based system but also to undertake a variety of video manipulations and analyses.

A number of systems are available for operating a video camera in response to the detection of motion. A motion detector associated with the video camera may operate the camera on and off. Thus, video may be captured only when motion is detected.

However, motion detection systems are often spuriously triggered. For example, background motion, such as motion in trees or curtains, may be sufficient to operate the motion sensitive video system.

In a variety of different circumstances, it may be desirable to detect actions undertaken by humans in an automated fashion. While a conventional processor-based video system can record what it in effect sees and subsequent analyses may be undertaken, it would be desirable if the camera could be tuned to particularly detect the human activities. While one approach is to use motion detection, these systems are subject to the deficiencies described above.

Thus, there is a need for a way to automatically detect, using video systems, activities associated with human beings.

### BRIEF DESCRIPTION OF THE DRAWINGS

FIG. 1 is a schematic depiction of one embodiment of the present invention;

FIG. 2 is a flow chart for software, in accordance with one embodiment of the present invention;

FIG. 3 is a flow chart for software, in accordance with another embodiment of the present invention;

FIG. 4 is a flow chart for software, in accordance with yet another embodiment of the present invention;

FIG. 5 is a flow chart for software, in accordance with still another embodiment of the present invention;

FIGS. 6A and 6B show a target being manipulated, in accordance with one embodiment of the present invention;

FIG. 7 is a block diagram of a video camera in accordance with one embodiment of the present invention;

FIG. 8 is a block diagram of a processor-based system in accordance with one embodiment of the present invention;

FIG. 9 is a schematic depiction of one embodiment of the invention;

FIG. 10 is a block diagram for hardware to implement the embodiments of FIG. 9; and

FIG. 11 is a flow chart for software for another embodiment of the present invention.

### DETAILED DESCRIPTION

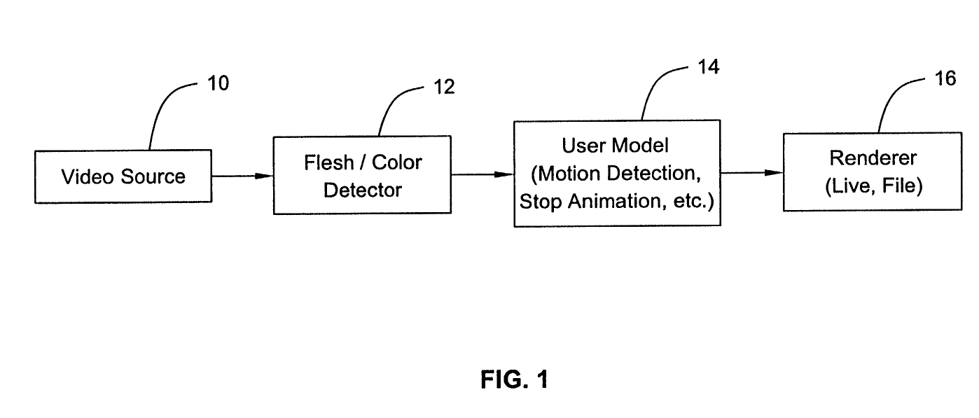

Referring to FIG. 1, a video source 10 may capture video of a desired target. A processor-based system associated with the video source 10 may detect a particular color or characteristic of human flesh as indicated at 12. This detection may be based on color characteristics such as vectors in a variety of color spaces including chroma, luminance, saturation and hue. For example, the chromaticity coordinates of a range of known human flesh tones may be compared to the chromaticity of various captured image elements.

Based on the match between known human flesh tone chromaticity characteristics and the captured image elements' chromaticity characteristics, one may determine whether or not the image element being detected is in fact a human figure.

The detector 12 may also augment the flesh tone detection with other information. For example, particular recognized shapes, such as hand shapes, may be associated with human beings. A combination of a relatively close match in chromaticity and a relatively close match in detected shape may be utilized to determine that the image element detected is in fact a human being.

Upon detection of human activity, a user model 14 may be implemented. In particular, a processor-based system may be controlled as indicated in block 14 based on the chromaticity, or other indicia, of human activity. A wide variety of user models 14 may be implemented, including a model that detects motion, not just of any entity, but particularly motion of human beings. In addition, the converse may also be utilized. Human activity may be detected and may removed from the captured video. Thus, the detection of the user's finger in the field of view over the video camera could be removed. Alternatively, the presence of the user moving an animated figure for creating an animated video may be detected and the human presence removed from the captured video screen.

Based on the user model 14, the video is then rendered, as indicated in block 16. For example, the video may be displayed in a live streaming video format or may be automatically stored as a file.

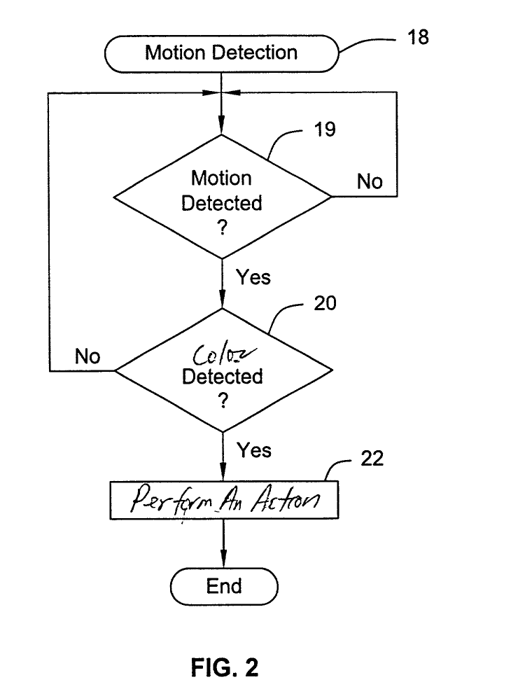

In one embodiment of the present invention, the user model 14 may implement a motion detection system using the software 18, illustrated in FIG. 2. If motion is detected at diamond 19, then a check determines whether the image element that is responsible for the detected motion has the specified color. In other words, in one embodiment, a check determines whether the object that is moving is in fact a human being based on flesh color tones. When flesh is detected as determined in diamond 20, an action is taken such as capturing video as indicated in block 22. In other embodiments, other activities may be triggered by the detection of motion of flesh colored objects including, as examples, recording video to disk, signaling an event to an application, and signaling a remote user or a network such as the Internet.

Unlike conventional motion detection systems, the video system implemented with the software 18 actually confirms, based on chromaticity or other information such as recognition of patterns associated with the human beings, that the detected motion is actually that of a human being. Thus, in some embodiments of the present invention, the detection of the flesh color, indicated in diamond 20, may be accomplished only after detecting motion.

While a wide variety of skin colors may be associated with human beings, the chromaticity characteristics of a variety of human flesh tones are sufficiently distinctive that they may be utilized to detect human presence. A variety of distinct flesh tones may be recorded in terms of chromaticity characteristics, in one embodiment of the present invention, and compared to the chromaticity of image elements captured in the motion detection system.

For example, the chromaticity coordinates, in accordance with known standards, for a variety of skin tones may be stored. One such standard is called the Commission Internationale de L'Eclairage (CIE) which defines a spectral energy distribution for each of three primary colors in the visible spectrum. Any color can be specified as one point in a chromaticity diagram. A range of colors may be specified as a region within a chromaticity diagram in accordance with the CIE standard. The CIE coordinates can then be readily converted to the red, green, blue (RGB) color space or any other known color space.

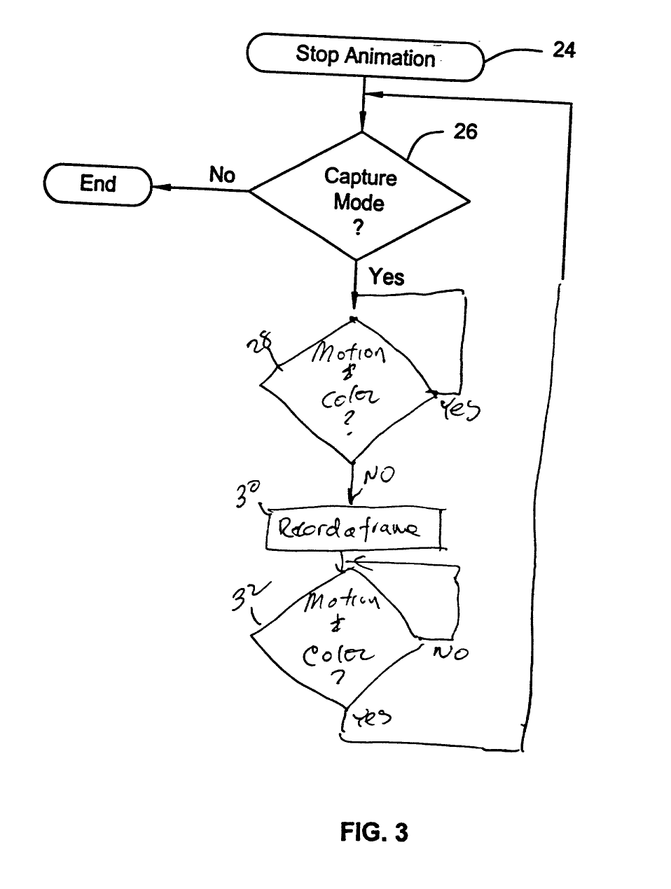

Turning next to FIG. 3, a stop animation embodiment may be implemented with the stop animation software 24 in accordance with one embodiment of the present invention. If the video system is in a capture mode, as determined in diamond 26, a check at diamond 28 determines whether there is motion within a specific color range. Again this may be done using a variety of different techniques, including pixel differencing and/or reference frame comparison. If so, the object is visible and the system waits until the object is no longer visible. At that time, a single frame of video is recorded as indicated in block 30.

A check at diamond 32 determines whether a moving image element is appropriately colored. If so, the flow iterates. If not, the flow waits since nothing is changing.

Thus, an animation object may be positioned within the field of view of a video camera. The user may manipulate the animation object to change its shape or position. By capturing a series of images of the animation object in different positions, the appearance of motion may be simulated.

Since the check at diamond 32 may determine whether flesh tones (or some other identifying colors) are present in the field of view of the camera, if the user is still manipulating the object, an additional delay is provided. The video capture system automatically captures the animation object, but only when the user is not present in the field of view. Thus, the animation object may be effectively automated.

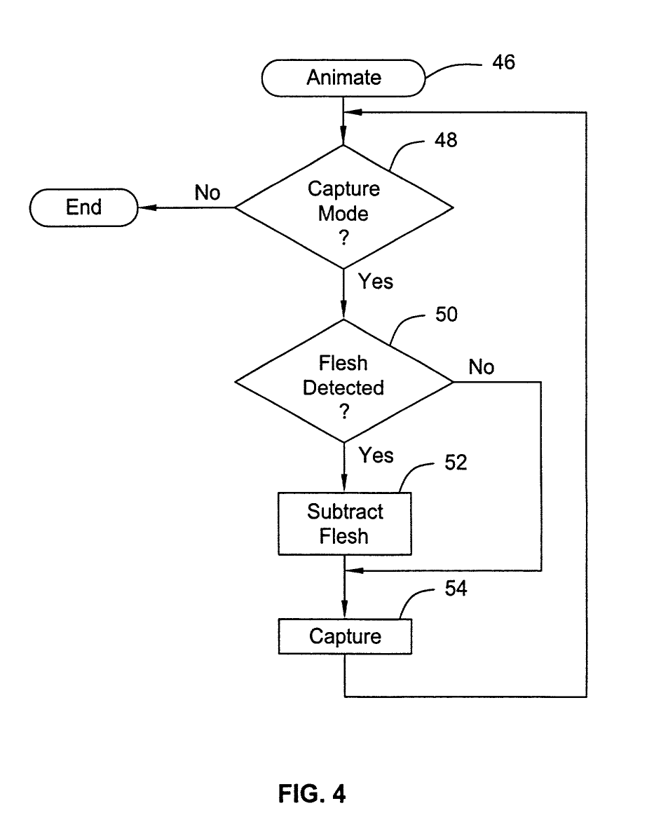

Turning next to FIG. 4, the animate software 46 may be utilized to implement an animation user model in one embodiment of the present invention. By detecting foreground motion and a flesh color and then subtracting the foreground flesh color from the scene, it is possible to continue to capture video frames even when the animator is manipulating the animation object without recording the animator's presence.

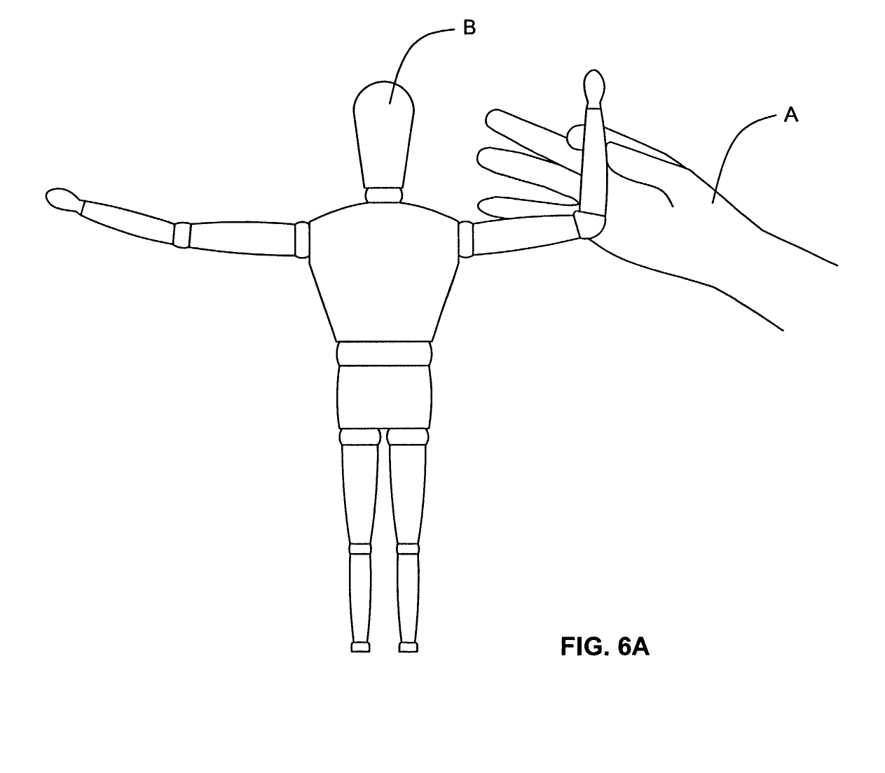

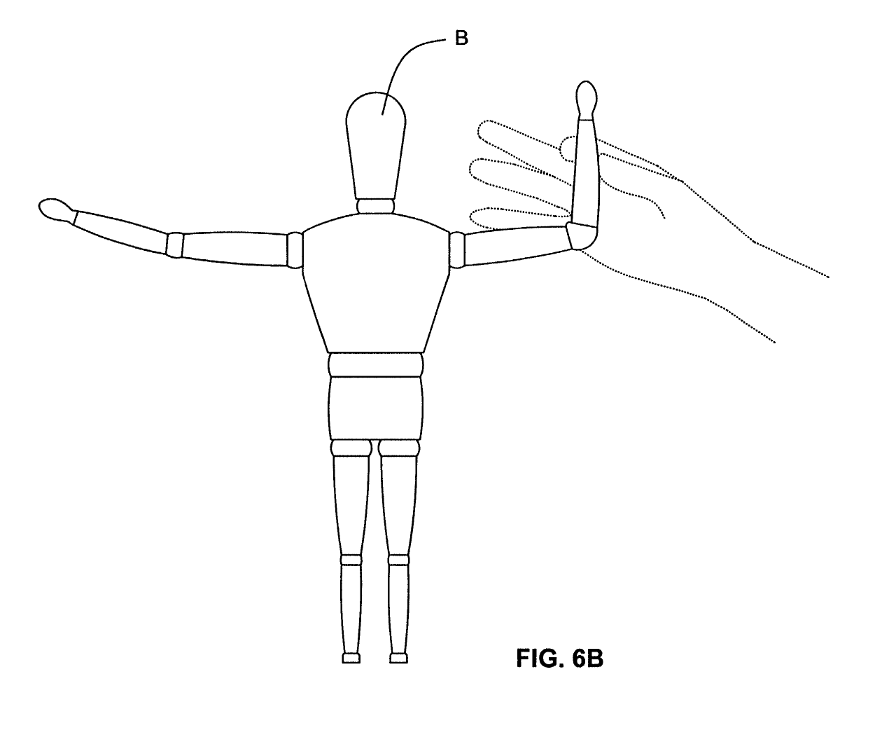

Thus, referring to FIG. 6A, the animator's hand A may manipulate the animation object B in a form of a mannequin. However, the captured image can appear, as indicated in FIG. 6B, with the animator's hand having been removed from the captured video frame. Thus, a video subtraction technique and flesh recognition enables continuous capture of frames and subsequent subtraction of the animator's intervention.

Initially, a check at diamond 48 (FIG. 4) determines whether the video capture system is in the capture mode. If so, and if flesh is detected as determined in diamond 50, the image element having the flesh tone is subtracted as indicated in block 52. Whether or not flesh is detected, the frame is processed as indicated in block 54.

In some embodiments of the present invention, the capture operation may be implemented on a periodic or timed basis. In other embodiments, capture may only be implemented after motion is detected and a time delay is provided.

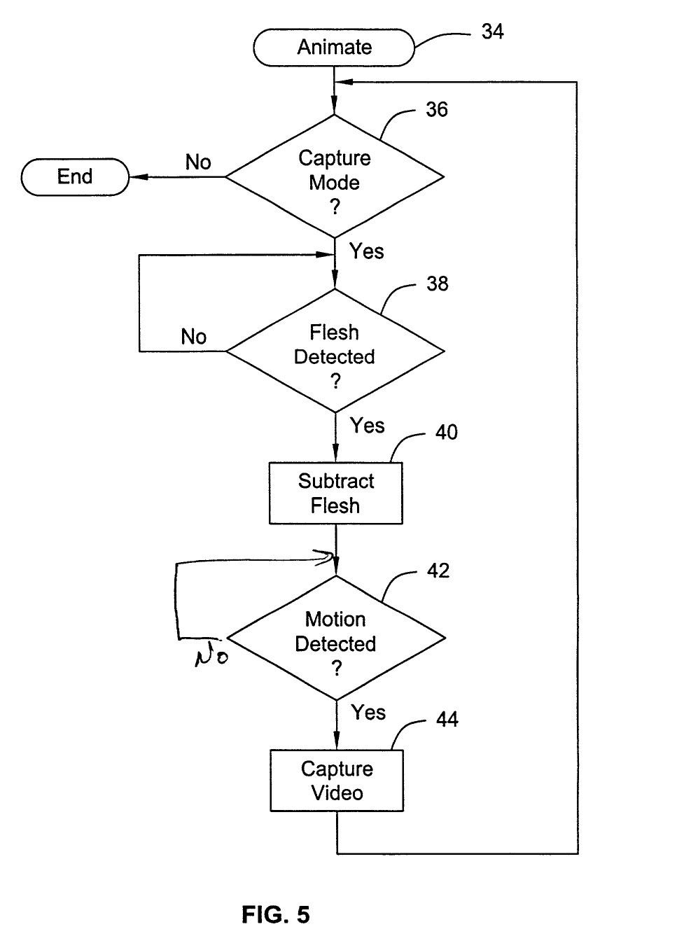

Referring to FIG. 5, the software 34 initially determines whether or not the system is in a capture mode as indicated at diamond 36. If so, a check at diamond 38 determines whether flesh is detected. If so, the flesh is subtracted from the captured video as indicated in block 40. Next, a check at diamond 42 determines whether motion is detected. Only after flesh has been subtracted and motion is detected is video captured. Thus, the system automatically captures the motion of a mannequin as one example subtracting any captured flesh and determining when motion has occurred and in that case capturing video of a new mannequin position.

In some cases, artifacts may remain after the flesh element is subtracted from the image. A variety of video processing algorithms may be utilized to remove the artifacts. In some cases, however, the artifacts may provide an enjoyable illusion that may be utilized for implementing a toy, for example.

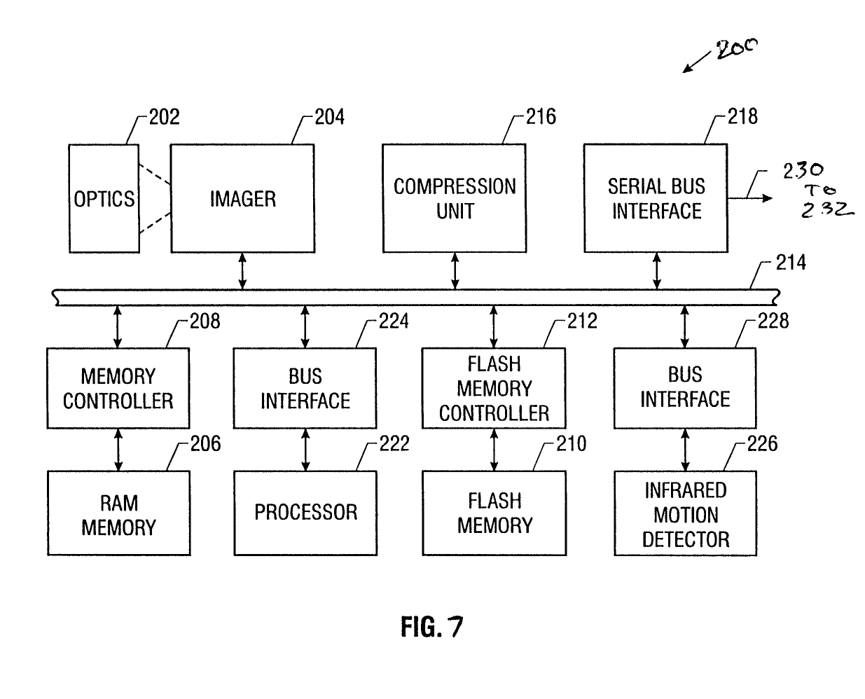

Referring to FIG. 7, a digital imaging device and motion detector 200, in accordance with one embodiment of the present invention, may include an optics unit 202 coupled to a digital imaging array or imager 204. The imager 204 is coupled to a bus 214. The optics unit 202 focuses an optical image onto the focal plane of the imager 204. The image data (e.g., frames) generated by the imager 204 may be transferred to an random access memory (RAM) 206 (through memory controller 208) or flash memory 210 (through memory controller 212) via the bus 214. In one embodiment of the present invention, the RAM 206 is a non-volatile memory.

The imaging device and motion detector 200 may also include a compression unit 216 that interacts with the imager 204 to compress the size of a generated frame before storing it in a camera memory (RAM 206 and/or flash memory 210). To transfer a frame of data to the processor-based system 232, the digital imaging device and motion detector 200 may include a serial bus interface 218 to couple the memory (RAM 206 and flash memory 210) to a serial bus 230. One illustrative serial bus is the Universal Serial Bus (USB).

The digital imaging device and motion detector 200 may also include a processor 222 coupled to the bus 214 via a bus interface 224. In some embodiments, the processor 222 interacts with the imager 204 to adjust image capture characteristics.

The motion detector 200 may include an infrared motion detector 226 coupled by a bus interface 228 to the bus 214. Ideally, the infrared motion detector 226 maps spatially into the same field of view as the imager 204. Alternatively, motion detection may be accomplished using the contents of a frame buffer by pixel differencing either on the imager 204 or by a firmware or by software on a host processor-based system.

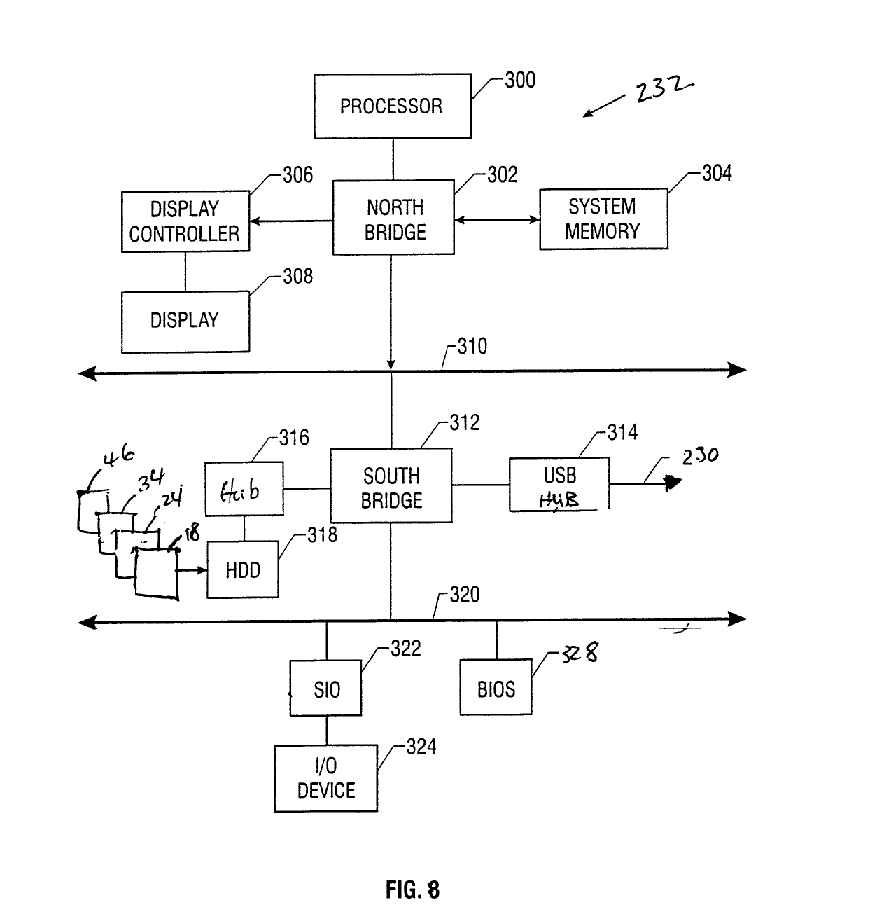

Referring to FIG. 8, the processor-based system 232 may include a processor 300 coupled to a north bridge 302. The north bridge 302 may be coupled to a display controller 306 and a system memory 304. The display controller 306 may in turn be coupled to a display 308. The display 308 may be a computer monitor, a television screen, or a liquid crystal display, as examples.

The north bridge 302 is also coupled to a bus 310 that is in turn coupled to the south bridge 312. The south bridge 312 may be coupled to a hub 316 that couples a hard disk drive 318. The hard disk drive 318 may store software 18, 24, 34 and 46, described earlier.

The south bridge 312 may also be coupled to a USB hub 314. The hub 314 in turn is coupled to the serial bus interface 218 of the digital imaging device and motion detector 200.

The south bridge 312 also couples a bus 320 that is connected to a serial input/output (SIO) device 322 and a basic input/output system (BIOS) memory 328. In addition, the SIO device 322 may be coupled to an input/output device 324 such as a mouse, a keyboard, a touch screen or the like.

The digital imaging device and motion detector 200 may detect both video data and information about whether or not motion is detected. This data may be transmitted as packets over the bus 230 to the processor-based system 232. In some embodiments, the serial bus interface 218 forms packets made up of image data including headers and payloads. That packetized data may include information about a plurality of pixels, pixel colors and intensity information.

In some cases, image data may be replaced with information about whether or not motion was detected. For example, a given frame of video made up of a plurality of pixels may be transmitted as one or more packets. Information encoded within the video data in response to detection of motion by the infrared motion detector 226 may be incorporated with the image data or the motion information may replace image data. Thus, the processor-based system 232 may depacketize the data received through the USB hub 314 and may extract information about whether motion was detected. In addition, the video data may be analyzed as well.

Thereafter, the software 18, 24, 34 and 46 may be utilized to control operations related to the video on the processor-based system 232. Those operations may include determining whether or not to store the captured video on the processor-based system 232 as described previously.

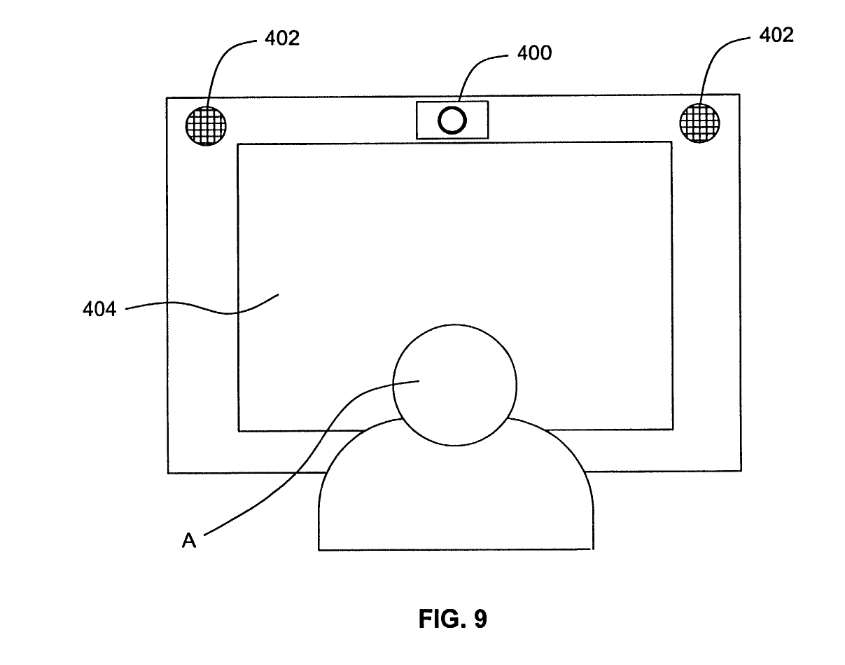

Referring to FIG. 9, a person who is speaking, (i.e., a speaker), indicated at A, may be positioned in front of a display screen 404 for a processor-based system. The display screen 404 may include a video camera 400 and a pair of left and right microphones 402. The microphones 402 may pick up speech from the user A, for example for speech recognition purposes as one example. The speech is captured by the microphones 402 and the speaker's location may be determined from video captured by the video camera 400.

In some cases, a pair of video cameras 400 may be utilized to order to provide stereoscopic vision. The use of a pair of video cameras may provide more accurate location of the user's face.

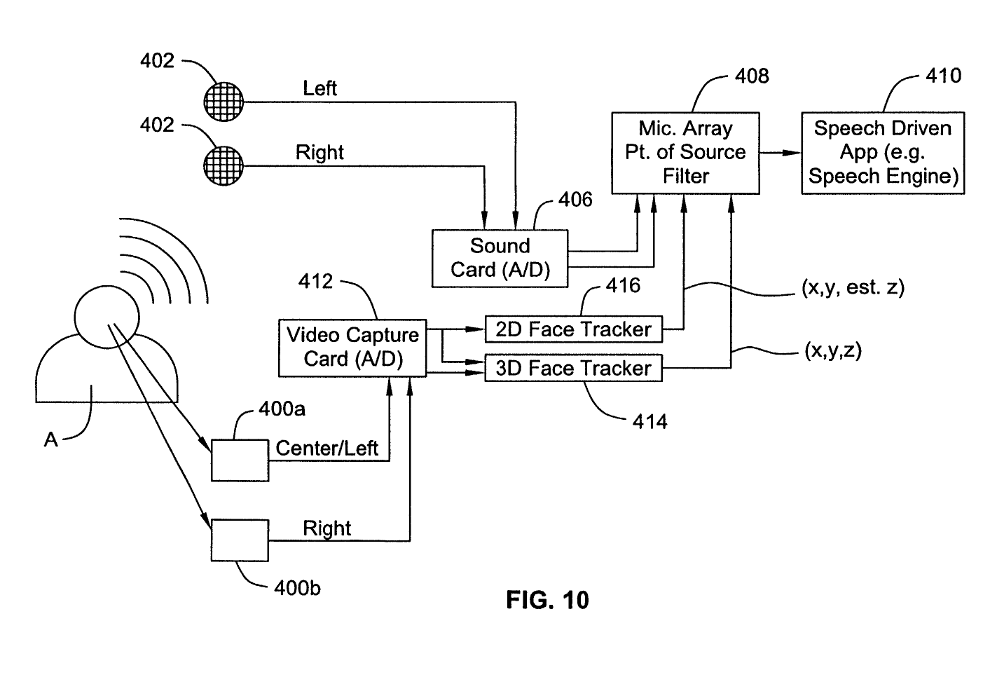

The position of the speaker indicated as A in FIG. 10 may be determined by one or more cameras 400. In some cases, a left and right camera set up may be utilized. The camera's video stream is fed to a video capture card 412 that converts the analog video to digital video information. The digital video information may be provided to a two dimensional face tracker 416 that determines the user's facial location in the video display. In some cases a three dimensional face tracker 414 may determine not only the location of the speaker's face relative to two dimensions but may actually determine a Z direction facial location, indicating how far away the user is from the microphones. In the case where a two dimensional face tracker 416 is utilized, the size of the speaker's face may be correlated to develop an estimated Z direction distance or spacing from the microphones 402.

At the same time, the microphones 402 pick up the sounds made by a speaker such as spoken commands. Those sounds are converted into analog signals that are received by a sound card 406. The sound card 406 converts the analog signals to digital signals and sends them to a microphone array and point of source filter 408. Based on the facial positioning determined by the trackers 414 or 416, the microphones 402 may be tuned to a speaker's position in three dimensions. That is, the further away from a given microphone the speaker is, the less information from that microphone is used to determine the spoken commands. This may result in picking up less noise by tuning an array of microphones so that the data picked up by the microphones closest to the user dominate the audio that is used as the speaker's input signal.

Once the microphone array is adequately adjusted, a speech application such as a speech engine 410 may receive the spoken commands. Thus, the sensitivity of the microphones 402 to background noise may be reduced by tuning to the microphones 402 closest to the speaker.

The use of the tuned microphones 402 based on speaker's position may be utilized in a wide variety of applications in addition to speech application such as speech engines. For example in connection with video conferencing, the sensitivity of the microphones may be altered based on whether the speaker is close to or far from the microphones. Thus, the video cameras are actually utilized to control the sensitivity of the microphone array.

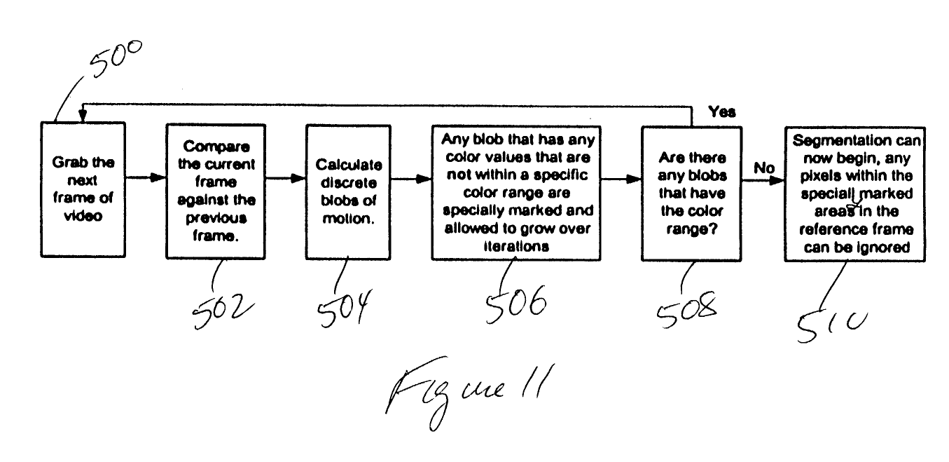

In one embodiment, shown in FIG. 11, a flesh aware reference frame calculation may be implemented. In this case color and especially flesh color information may be used to aid in the determination of a reference frame. A reference frame identifies the information that is background information. For example, when a weather man stands in front of a map, the reference frame may be the picture of the map without the weather man.

In conventional segmentation algorithms, the user must move out of the picture to enable the background reference frame to be developed. Unfortunately, if there is motion in the background then the reference frame will never get calculated. A modified flesh color motion detector may calculate the reference frame. Referring to FIG. 11, in block 500, the next frame of video is grabbed. The current and previous frames are compared as indicated in block 502.

Discrete blobs of motion are calculated as indicated in block 504. A blob may be composed of all areas that have motion. Background is any area that has motion outside of a specific color range that can not be connected spatially to blobs within the color range. Background areas are ignored as indicated in block 506.

A check at 508 determines whether there are any blobs that have the color range. If so, the flow iterates. Otherwise, segmentation may now begin and any pixels within the specially marked areas in a reference frame can be ignored. The reference frame can be accumulated over time, and these background blobs of motion can be grown into identified dead spaces in the referenced frame.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
detecting a color characteristic;
detecting motion; and
controlling a processor-based system based on the detection of motion and a color characteristics.

2. The method of claim 1 including controlling a processor-based system based on the detection of flesh color and the detection of a shape associated with a human being.

3. The method of claim 2 including determining whether to process image data depending on whether both motion and flesh are detected.

4. The method of claim 2 including capturing a frame of video at a time, and determining after capturing each frame whether or not flesh color has been detected.

5. The method of claim 4 including removing the flesh color from the captured video.

6. The method of claim 5 including moving an animation object while capturing video and removing the detected flesh color from the captured video.

7. The method of claim 1 including capturing video of an animation object in a plurality of different positions and automatically removing an image of a user's hand from the captured video.

8. An article comprising a medium storing instructions that enable a processor-based system to:
detect a color characteristic;
detect motion; and
control a processor-based system based on the detection of motion and the color characteristic.

9. The article of claim 8 further storing instructions that enable the processor-based system to be controlled based on the detection of flesh color and the detection of a shape associated with a human being.

10. The article of claim 9 further storing instructions that enable the processor-based system to determine whether to process image data depending on whether motion and flesh are detected.

11. The article of claim 9 further storing instructions that enable the processor-based system to capture a frame of video at a time and determine after capturing each frame whether flesh color has been detected.

12. The article of claim 9 further storing instructions that enable the processor-based system to remove the flesh color from the captured video.

13. The article of claim 12 further storing instructions that enable the processor-based system to capture video of an animation object in a plurality of different positions and automatically remove an image of a user's hand from the captured video.

14. A system comprising:
a processor;
a storage coupled to said processor storing instructions that enable the processor to detect motion and a color characteristic and to control the system based on the detection of motion and the color characteristic.

15. The system of claim 14 wherein said storage further stores instructions that enable the processor to detect a shape associated with a human being.

16. The system of claim 14 further storing instructions that enable the processor to determine whether to process image data depending on whether motion and flesh color are detected.

17. The system of claim 14 including a digital imaging device coupled to said processor.

18. A method comprising:
capturing a video image of a speaker;
receiving audio information from the speaker through at least one microphone;
determining the user's position; and
based on the user's position, adjusting a characteristic of the microphone.

19. The method of claim 18 including receiving audio information from a pair of microphones and adjusting the sensitivity of the microphones based on the relative positioning of the user with respect to each microphone.

20. The method of claim 18 including tracking the user's facial position in two dimensions and estimating the user's facial position in a third dimension.

21. The method of claim 18 including tracking the user's facial position in three dimensions.

22. The method of claim 18 including using a point of source filter to adjust the audio information received from the user and providing said adjusted audio information to a speech recognition engine.

23. A system comprising:
a video capture device for capturing an image of a user;
at least one microphone for capturing speech from said user;
a device to determine the user's position with respect to at least two microphones and to adjust the data from each microphone in response to the user's position relative to each microphone.

24. The system of claim 23 including a pair of video cameras for capturing an image of said user.

25. The system of claim 23 including a two dimensional face tracker that locates the user's face in two dimension.

26. The system of claim 23 including a three dimensional face tracker that locates the user's face in three dimensions.

27. The system of claim 23 including a point of source filter to adjust the sensitivity of said microphones.

28. A method comprising:
identifying a color;
identifying motion; and
using identified color and motion to implement background segmentation.

29. The method of claim 28 including determining areas that are moving of a particular color.

30. The method of claim 29 including identifying objects that are connected to moving objects of a particular color.
